(19) United States
(12) Patent Application Publication
(10) Pub. No.: US 2004/0192361 A1
(43) Pub. Date: Sep. 30, 2004

(54) Reliable telecommunication

(75) Inventors: Yossi Yossef, Petach Tikva (IL); Rafi Hana, Yavne (IL); Yehuda Eder, Rishon-Lezion (IL)

Correspondence Address: DENNISON, SCHULTZ, DOUGHERTY & MACDONALD, 1727 KING STREET, SUITE 105, ALEXANDRIA, VA, 22314, US

(73) Assignee: Tadiran Communications Ltd.

(21) Appl. No.: 10/402,146

(22) Filed: Mar. 31, 2003

(51) Int. Cl. H04B 1/00

(52) U.S. Cl. 455/505; 455/43

(57) ABSTRACT

A communications system includes a transmission system and a receiver system for enabling telecommunication of a voice signal on an appropriate carrier wave across a medium at a low bit-rate and consequently, with high reliability.

### FIELD OF THE INVENTION

The present invention relates to communication, and particularly to a method and system for the wireless transmission and reception of speech, having high levels of reliability.

### BACKGROUND OF THE INVENTION

There are many scenarios where it is necessary to transmit a message through the atmosphere, such that it is imperative that the message arrives in a manner that can be understood. Such applications include communication with a boat at sea, where, there it is advantageous that communication be by radio transmission of the voice, so that an inexperienced yachtsman, or a passenger can transmit and receive the spoken word. Another application is the need to transmit or receive spoken commands by embassy staff in an emergency, where regular communication lines are disrupted. A third scenario is communicating with a spy deep behind enemy lines.

The general trend in telecommunication advances is to allow the quality transmission of large amounts of undistorted data in real-time. Domestic users of the Internet, for example, require the transmission and reception of very large amounts of data, such as the downloading or uploading of films or music. In applications of this nature it is imperative that the quality of the signal remains high. It is also generally important that the transmission times be kept reasonable, and to serve these ends, telecommunication is generally over a fiber-optic link, and only rarely is part of the communication path through the atmosphere.

In regular telephony, including portable telephony and mobile phone telephony, whilst it is true that the quality of reception is tailored to voice, it is necessary for communication to occur substantially in real time, such that a two way conversation can be maintained without transmission pauses resulting in both sides talking at once.

This requirement puts high demands on the equipment, and in poor conditions, the signal received is often incomprehensible.

Thus despite the major advances in telecommunication, and the many and varied methods and equipment for vocal telecommunication, there is a long-felt need for a system and method for reliable voice communication in adverse conditions, and the present invention is directed to providing novel solutions to this need.

The present invention aims to provide appropriate equipment and a method for wireless voice communication with very high reliability levels, appropriate for adverse conditions, where high fidelity transmission is not necessary, and where, since normal two-way conversation is not a priority, delays in transmission are acceptable.

### SUMMARY OF THE INVENTION

In accordance with a first aspect of the present invention, there is provided a telecommunication system comprising a transmission system and a receiver system for enabling voice communication across a medium on an appropriate carrier wave, at a low transmission bit-rate, but with high reliability.

The medium is typically the atmosphere.

Optionally the carrier wave is a High Frequency (HF) radio wave or a Very High Frequency (VHF) radio wave.

In one embodiment, the transmission system for transmission of a voice signal into the medium, comprises an audio to analog transducer having an output coupled to an input of an analog to digital coder having an input and an output; the output of the analog to digital coder for outputting data at a first bit-rate ‘A’, being further coupled to an input of a cache memory having an input and an output; the output of the cache memory being further coupled to an input of a modulator and transmitter unit having an input and an output;

the output of the modulator and transmitter unit being coupled to an antenna for transmission of data at a second bit-rate ‘B’; the transmission system being characterized by the transmission bit-rate ‘B’ being lower than the first bit-rate ‘A’.

Typically, the audio to analog transducer comprises a microphone.

Typically, the analog to digital coder comprises a vocoder.

Optionally, the transmission system further comprises an encryption unit for encryption of the data prior to transmission. The encryption unit may be coupled between the analog to digital coder and the cache memory for example.

In one embodiment, the receiver system of claim 1 comprises a receiver end antenna coupled to a receiver-end receiver and demodulator unit for receiving and demodulating a signal detected by the receiver end antenna; a receiver end memory coupled to the receiver end receiver and demodulator unit and further coupled to a digital-to-analog converter; the digital-to-analog converter being further coupled to an analog to audio transducer for producing a voice signal, wherein the bit-rate of the output of the digital to analog converter ‘A’ is higher than the transmission bit-rate ‘B’ across the medium.

Typically, the receiver-end receiver and demodulator unit includes a modem.

Typically, the digital to analog converter is a vocoder.

Typically, the analog to audio transducer includes a speaker.

Optionally, the receiver system further comprises a decryption unit.

In preferred embodiments, the communication system is a two way system; wherein the transmission system and the receiving system are both transceivers, and are able to function as transmitters and receivers.

In a second aspect, there is provided a method by which a voice signal may be transmitted reliably through a medium under adverse conditions comprising the following steps:

(a) a speaker talking into a microphone;

(b) converting speech into an electrical analog;

(c) feeding electrical analog into an analog to digital converter to convert it into a digital signal having a first bit-rate ‘A’;

(d) caching the digital signal in a memory;

(e) reducing the bit-rate from bit-rate ‘A’ to bit-rate ‘B’, where A>B;

(f) modulating the reduced bit-rate signal and transmitting it at a radio frequency, via an antenna into the medium at a reduced bit-rate.

Optionally the method further includes an encryption step prior to the transmission step.

Typically the radio frequency is selected from the list of High Frequency (HF) and Very High Frequency (VHF).

Typically the medium is an atmosphere.

In a third aspect, there is provided a method by which a radio frequency atmospherically transmitted digital signal at reduced bit-rate as described hereinabove is converted into a voice signal, comprising the following steps:

(i) receiving said radio frequency, reduced bit-rate atmospheric digital signal via an antenna;

(ii) demodulating received signal;

(iii) caching the digital signal in a memory;

(iv) converting digital signal into an electrical analog signal and restoring the original bit-rate;

(v) converting electrical analog signal into an audible signal.

Where the method by which the voice signal is converted into an atmospherically transmitted digital signal as described hereinabove, included an encryption stage, the method by which the atmospherically transmitted digital signal be converted into a voice signal, further includes a corresponding decryption step after the step of receiving the transmitted signal and prior to the step of converting the electrical analog signal into an audible signal.

### BRIEF DESCRIPTION OF THE DRAWINGS

The present invention will be further understood and appreciated from the following detailed description taken in conjunction with the drawings in which:

FIG. 1 is a schematic block diagram of a communication system in accordance with the present invention.

FIG. 2 is a flow chart showing a method of converting a voice signal into a digital signal having a low bit-rate, for carrying on an appropriate carrier wave, enabling voice telecommunication with very high reliability, and being particularly appropriate for adverse conditions, in accordance with the present invention.

FIG. 3 is a flow chart showing a method of converting a reduced bit-rate digital signal carried on an appropriate carrier wave into a voice signal.

### DETAILED DESCRIPTION OF THE INVENTION

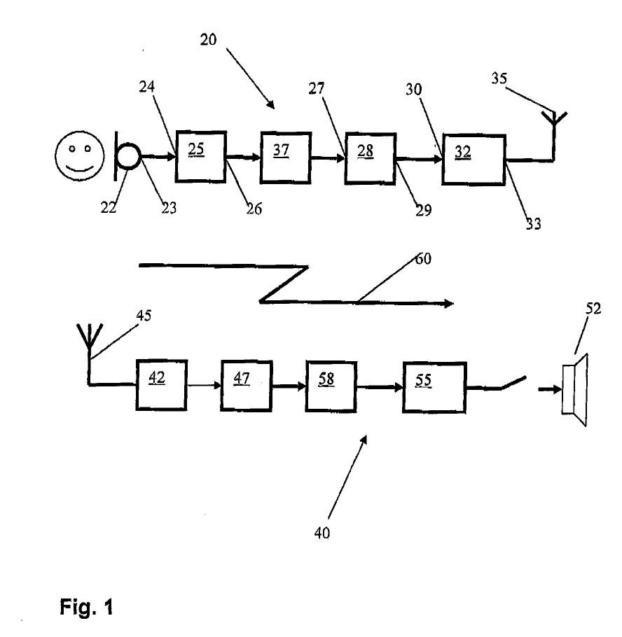

With reference now to FIG. 1, there is shown a telecommunication system 10 comprising a transmission system 20 and a receiver system 40 for enabling voice communication across a medium 60 at a low bit-rate and consequently, by a high reliability.

Typically the low bit-rate transmission rate through the medium is carried by a High Frequency (HF) or Very High Frequency (VHF) carrier wave, and the system is particularly appropriate for direct land to land atmospheric transmissions, and for indirect land to land transmissions, via a satellite link, or by bouncing the signal off the ionosphere.

The transmission system 20 for transmitting a voice signal into the medium 60 comprises the following functional elements connected in series: an audio to analog transducer 22, typically including a microphone, having an output 23 coupled to an input 24 of an analog to digital coder 25, such as a vocoder, having an input 24 and an output 26; the output 26 of the analog to digital coder 25 for outputting data at a first data rate ‘A’, being further coupled to an input 27 of a memory 28 having an input 27 and an output 29; the output 29 of the memory 28 being further coupled to an input 30 of a modulator and transmitter unit 32 having an input 30 and an output 33; the output 33 of the modulator and transmitter unit 32 being coupled to an antenna 35 for transmission of data at a second data-rate ‘B’; the transmission system 20 being characterized by the bit-rate ‘B’ therefrom being lower than the first data-rate.

Where required, such as for use in espionage, in the diplomatic service, or wherever the data is both sensitive and is broadcast into the atmosphere rather than transmitted down a secure line, the transmission system 20 may advantageously include an encryption unit 37 for encryption of the data prior to its transmission. Such an encryption unit 37 may be situated anywhere upstream of the antenna, but it has been found particularly advantageous for the encryption unit 37 to be situated between the analog to digital coder 25 and the memory 28.

In use, the audio to analog transducer 22 converts the spoken sound from a person speaking thereinto, into an electrical analog signal which is then coded into a digital signal by the analog to digital coder 25, or voice coder, that is connected thereto. The analog to digital coder 25 outputs digital data at a first bit-rate such as 2400 bit/second for example, the output data from the analog to digital coder 25 is input into a memory 28 wherein it is cached. The cached signal is output to a modulator and transmitter unit 32, or modem, which transmits the signal via an antenna 35 at a second bit-rate, on an appropriate carrier wave, typically an HF or VHF radio wave. It is an important feature of the invention that the transmission system 20 has a transmitted bit-rate from the modulator and transmitter unit 32 thereof, which is lower than the bit-rate output of the vocoder. By the transmission unit transmitting the digitized voice signal at a lower bit-rate than that produced by the digitization, the reliability of the transmission is increased.

In addition to the transmission system 20, the telecommunication system 10 also includes at least one receiver system 40 comprising: a receiver end antenna 45 coupled to a receiver-end receiver and demodulator unit 42, typically a modem, for receiving and demodulating a signal detected by the receiver end antenna 45. Coupled to the receiver end receiver and demodulator unit 42 there is provided a receiver end memory 58, which serves as a cache, and feeds into a digital-to-analog converter 55, typically a vocoder, to which is connected an analog to audio transducer 52, such as a speaker, for converting the electrical signal into an audible, voice signal.

Where the transmission system 20 includes an encryption unit 37, the receiver system 40 is required to include an appropriate decryption unit 47.

For many applications, voice transmission need be unidirectional only. In other applications, it is advantageous or even necessary for bidirectional communication, and in suitable embodiments, the telecommunication system 10 will be a two way system; wherein the transmission system further comprises additional parts and is able to function as a receiving system, and the receiving system comprises additional parts and is able to function as a transmission system. A two-way transmitter/receiver system may comprise a transmission system 20 and a receiver system 40 as described above. Typically however, the same functional elements will be used for both transmission and reception.

The telecommunication system described hereinabove is typically utilized for transmission of speech. It will be appreciated that in contradistinction to data transmission systems for transmitting digital data over the Internet, and other telecommunication systems bearing a facile resemblance, since this telecommunication system is designed for transmission and reception of low fidelity and high intelligibility voice messages, the voice signal generated at the receiver end need not be accurate representation of that converted into an electrical signal by the transmission system. It is merely required to be comprehendible by the listener.

One consequence of the above is that there is no need for the telecommunication system to include any checks to ensure that all data bits are reliably transmitted, as are generally required in data communication systems.

It will be appreciated however, that some such checking system will be advantageous and may be included.

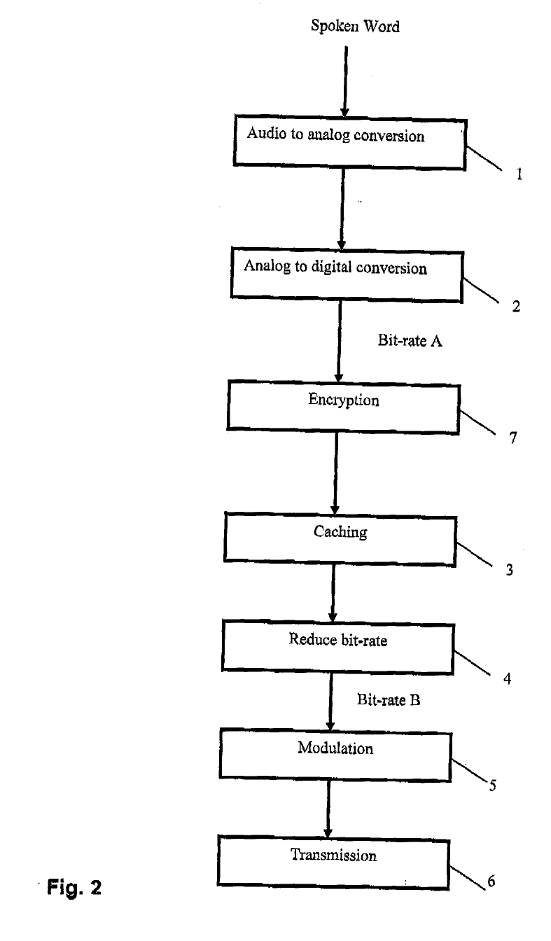

With reference now to FIG. 2, there is shown a flowchart illustrating the method by which a voice signal may be transmitted as an electromagnetic wave, reliably through a medium, such as the atmosphere under adverse conditions. Firstly, the speaker talks into a microphone, which converts the audio signal from the voice, into an electrical analog thereof (Step 1). The electrical analog is fed into an analog o digital converter such as a vocoder (Step 2), which produces a digital signal having a bit-rate ‘A’, which is then cached in a memory (Step 3). The digital signal has its bit-rate reduced to a lower bit-rate ‘B’ (Step 4), which is modulated (Step 5), and transmitted (Step 6) via an antenna into the medium.

Where appropriate, the transmission method may include an encoding step (Step 7), and the transmitted signal may be encrypted.

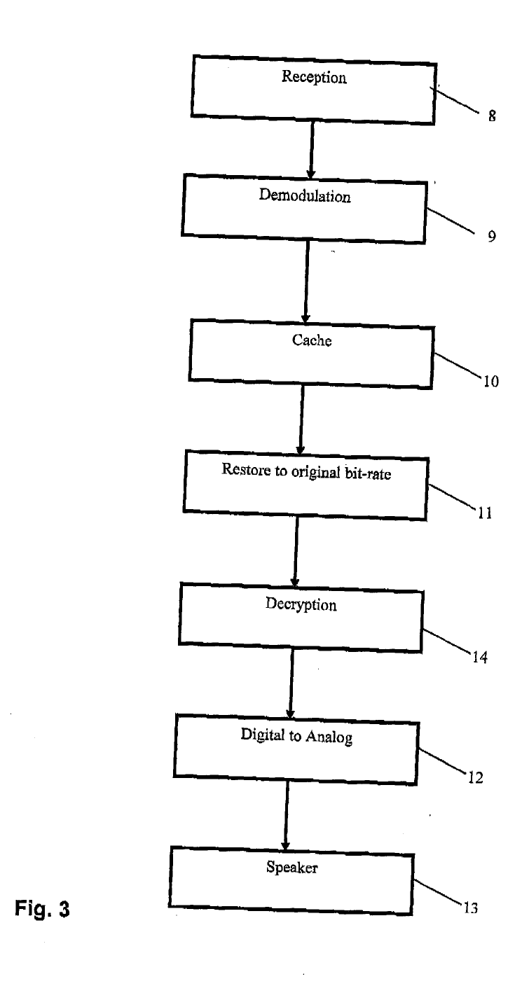

With reference now to FIG. 3, there is shown a flowchart illustrating the method by which a reduced frequency digital signal is detected and a voice signal is reproduced for a listener.

Firstly, a second (receiver end) antenna receives (Step 8) the reduced frequency voice signal. The received signal is demodulated (Step 9), the restored digital signal is cached in a memory (Step 10), and its bit-rate is restored (Step 11) from reduced bit rate B to original bit rate A. The cached signal is converted (Step 12) into an analog signal and fed to a transducer such as a speaker or similar, which reproduces a voice signal (Step 13) that, though not necessarily a high quality reproduction of the original signal, is nevertheless comprehendible to the listener, such that he can discern the words spoken, using the system of FIG. 1.

Where the transmitted signal is encrypted, the method of receiving and reproducing the voice signal includes an appropriate step of decryption (Step 14).

It will be appreciated that the invention is not limited to what has been described hereinabove merely by way of example. Rather, the invention is limited solely by the claims which follow.

What is claimed is:

1. A communication system comprising a transmission system and a receiver system for enabling telecommunication of a voice signal on an appropriate carrier wave across a medium at a low bit-rate and consequently, with a high reliability.

2. A communication system as claimed in claim 1, the medium being an atmosphere.

3. A communication system as claimed in claim 1, the carrier wave being selected from the list of High Frequency (HF) radio waves and Very High Frequency (VHF) radio waves.

4. A transmission system as claimed in claim 1 for transmission of a voice signal into the medium, comprising:
An audio to analog transducer having an output coupled to an input of an analog to digital coder having an input and an output;
the output of the analog to digital coder for outputting data at a first date rate, being further coupled to an input of a cache memory having an input and an output;
the output of the cache memory being further coupled to an input of a modulator and transmitter unit having an input and an output;
the output of the modulator and transmitter unit being coupled to an antenna for transmission of data at a second data-rate; the transmission system being characterized by the transmission rate being lower than the first date-rate.

5. The transmission system of claim 4, wherein the audio to analog transducer comprises a microphone.

6. The transmission system of claim 4, wherein the analog to digital coder comprises a vocoder.

7. The transmission system of claim 4, further comprising an encryption unit for encryption of the data prior to transmission.

8. The transmission system of claim 7, the encryption unit being coupled between the analog to digital coder and the cache memory.

9. The receiver system of claim 1 comprising: a receiver and anenna coupled to a receiver-end receiver and demodulator unit for receiving and demodulating a signal detected by said receiver end antenna;
a receiver end memory coupled to said receiver end receiver and demodulator unit and further coupled to a digital to analog converter;
said digital to analog converter being further coupled to an analog to audio transducer for producing a voice signal, wherein the frequency of the output of the digital to analog converter is higher than the transmission rate across the medium.

10. The receiver system of claim 9 wherein the receiver-end receiver and demodulator unit includes a modem.

11. The receiver system of claim 9 wherein the digital to analog converter is a vocoder.

12. The receiver system of claim 9 wherein the analog to audio transducer includes a speaker.

13. The receiver system of claim 9 further comprising a decryption unit.

14. The communication system of claim 1 being a two way system; wherein the transmission system and the receiving system are transceivers, being able to receive and transmit.

15. A method by which a voice signal may be transmitted reliably through the atmosphere under adverse conditions comprising the steps of:
(a) a speaker speaking into a transducer;
(b) converting speech into an electrical analog by the transducer;
(c) feeding electrical analog into an analog to digital converter to convert said analog into a digital signal having a bit-rate ‘A’;
(d) caching the digital signal in a memory;
(e) reducing the bit-rate to a reduced bit-rate ‘B’, where B<A;
(f) modulating and transmitting said reduced bit-rate signal via an antenna into the medium.

16. The method of claim 15 further including an encryption step prior to the transmission step.

17. The method of claim 15, wherein the radio frequency is selected from the list of High Frequency (HF) and Very High Frequency (VHF).

18. The method of claim 15, wherein the medium is an atmosphere.

19. A method by which an atmospherically transmitted digital signal of claim 16 is converted into a voice signal, comprising the following steps:
(i) receiving said digital signal at reduced bit-rate ‘B’ from medium, via an antenna;
(ii) demodulating received signal;
(iii) caching the digital signal reduced bit-rate in a memory;
(iv) restoring digital signal at reduced bit-rate ‘B’ to original bit-rate ‘A’;
(v) converting digital signal into an electrical analog signal;
(vi) converting electrical analog signal into an audible signal.

20. The method of claim 19 further including a decryption step after the step of receiving the transmitted signal and prior to step (vi).
